(19) United States
(12) Patent Application Publication
(10) Pub. No.: US 2012/0210253 A1
(43) Pub. Date: Aug. 16, 2012

(54) UNIFIED ACCESS AND MANAGEMENT OF EVENTS ACROSS MULTIPLE APPLICATIONS AND ASSOCIATED CONTACTS THEREOF

(76) Inventors: Michael Luna, San Jose, CA (US); Isabelle Dumont, Half Moon Bay, CA (US); Steven L. Peterson, Los Gatos, CA (US); Anthony Stevens, San Francisco, CA (US); Ronald G. Earley, Pleasanton, CA (US)

(21) Appl. No.: 13/349,345

(22) Filed: Jan. 12, 2012

Related U.S. Application Data
(60) Provisional application No. 61/432,143, filed on Jan. 12, 2011.

(51) Int. Cl. G06F 3/048; G06F 15/16; G06F 3/01

(52) U.S. Cl. 715/753; 715/835

(57) ABSTRACT

Systems and methods for unified access and management of events across multiple applications and the associated contacts thereof are disclosed. In one aspect, embodiments of the present disclosure include a method, which may be implemented on a system, for enabling multi-application access of associated events via a single interface, including, depicting in the single interface on a device, representations of multiple applications available for access at the device where the single interface is further populated with the events associated with the multiple applications. One embodiment further includes, updating the single interface to visually depict recent events received content from the multiple applications where each of the representations in the single interface, are selectable or actionable to access application features of a corresponding application in a different interface.

### CLAIM OF PRIORITY

This application claims priority to U.S. Provisional Patent Application No. 61/432,143 entitled “UNIFIED CONTACT BASED MESSAGING INTERFACE,” which was filed on Jan. 12, 2011, the contents of which are expressly incorporated by reference herein.

### FIELD OF TECHNOLOGY

The present disclosure relates generally to a user environment and more particularly to a mobile user environment for unified viewing and simultaneous access of mobile applications and/or other device features including mobile device/phone features.

### BACKGROUND

As our day to day activities become ever more reliant on support or enhancement via applications or other software tools, such as mobile applications/services, a growing problem facing a typical end user of a mobile device is that of the ability to efficiently access cross-application updates and events. Another challenge is to effectively monitor and navigate to and through the multiple services to which they are subscribed to use the desired feature or to access a given update or event. The issue is further exacerbated given the valuable real state on a device screen of a mobile device, which, given the popularity of touch screen devices, now is needed for both accessing/viewing content and for receiving user input.

Further complexity is introduced as messages or events are received in multiple different formats over multiple communications channels (email, status updates, feeds, news feeds, SMS, IM, social networks (e.g., “tweets”, Facebook generated messages, etc.)) across multiple applications. Thus, the messages intended for a user may need to be accessed by using and therefore launching different applications, with each application generating notifications, status indications, etc. and taking up valuable device screen real estate. The overall situation is one of complexity and impacts usability, with multiple events and messages spread across different applications and various communication channels. As a result, there is no intuitive way to present events, statuses or messages to a user and to enable them to view, respond to, or otherwise access the application events in an efficient and productive manner.

### BRIEF DESCRIPTION OF THE DRAWINGS

FIG. 1A illustrates examples of devices with user environments able to provide unified access and management of events across multiple applications and the associated contacts.

FIG. 1B illustrates examples of devices with user environments able to provide unified access and management of events across multiple applications and the associated contacts with support of servers and services across one or more networks.

FIG. 2 depicts a block diagram illustrating example components of mobile device architecture which provides capabilities including user interface features and functions for unified access and management of events across multiple applications and the associated contacts.

FIG. 3 depicts a block diagram illustrating example components of a contact-oriented messaging agent to facilitate unified access and management of events across multiple applications and associated contacts.

FIG. 4 depicts a block diagram showing contact mapping of a user's contacts across multiple sources into a single contact database.

FIG. 5 depicts a flow chart illustrating example processes through which multi-application access of associated events can be enabled via a single interface.

FIG. 6 depicts a flow chart illustrating an example process for facilitating communication with a user via multiple applications through a unified user interface on a mobile device.

FIG. 7 depicts a flow chart illustrating example process for simplifying navigation to access frequently accessed features of multiple services.

FIG. 8 depicts example screenshots showing how multiple applications, their events, updates, and the associated contacts are scattered across multiple different user interfaces.

FIG. 9 depicts an example screenshot showing how multiple applications, their events, updates, and the associated contacts which are typically scattered across multiple different user interfaces can be unified in a single interface in a mobile user environment.

FIG. 10 depicts example screenshots of a unified user interface for accessing contacts, applications/updates, and an indicator for a default communication channel which can be used to initiate a communication session with an active contact in the unified user interface.

FIGS. 11A-B depict example screenshots of a unified user interface for accessing contacts, applications/updates, and indication of a preferred communication channel of the active contact which can be activated to initiate communication with the active contact.

FIGS. 12A-B depict example screenshots of a unified user interface where a representation of an application is selectable or actionable to access its additional features in a different interface.

FIGS. 13A-B depict tables listing example features of across multiple applications which can be provided via a unified interface for access and management.

FIG. 14 depicts screenshots showing a chat application utilizing SMS-based registration.

FIG. 15 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the present disclosure include systems, apparatuses and methods of unified access and management of events across multiple applications and associated contacts thereof. Embodiments of the present disclosure further include systems, apparatuses, and methods for generating a user interface on a mobile device, and more specifically, to the generation of a unified messaging interface that enables a user to interact with multiple messaging applications and is organized based on a user's contacts.

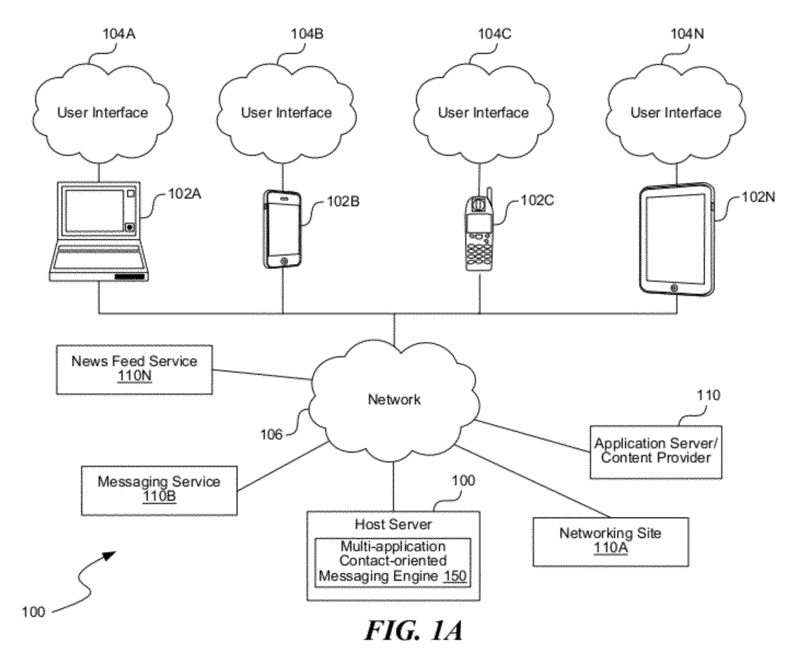

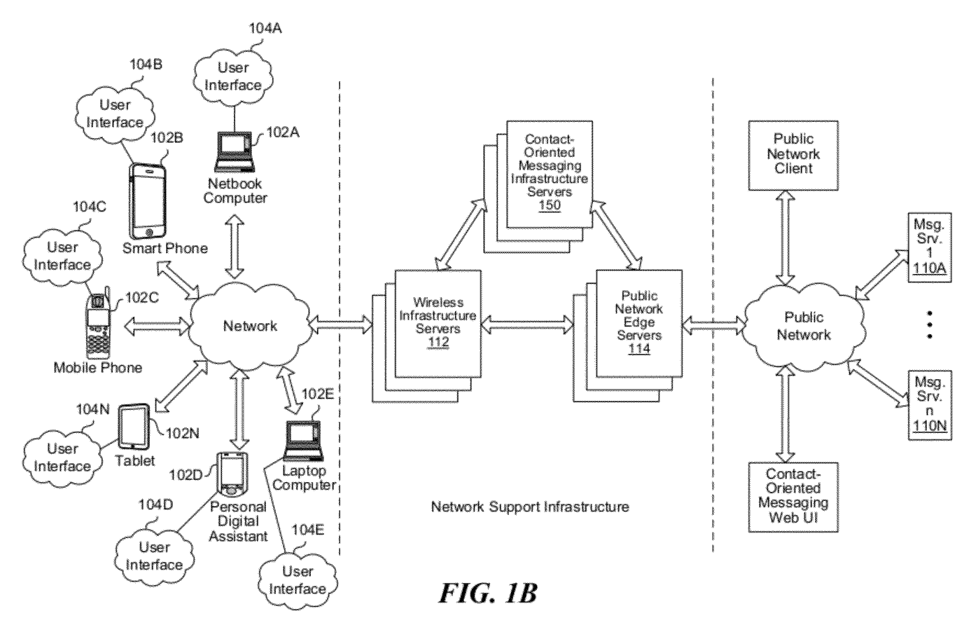

FIG. 1A illustrates examples of devices 102A-N with user environments able to provide unified access and management of events across multiple applications 110 and the associated contacts.

The client devices 102A-N can be any system and/or device, and/or any combination of devices/systems that is able to establish a connection with another device, a server and/or other systems such as host server 100 and/or application server/content provider 110. Client devices 102A-N each typically include a display and/or other output functionalities to present information and data exchanged between among the devices 102A-N and/or the host server 100 and/or application server/content provider 110.

For example, the client devices 102A-N can include mobile or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g., an iPad), a handheld console, a handheld gaming device or console, an iPhone, and/or any other portable, mobile, handheld devices, etc. In one embodiment, the client devices 102A-N and host server 100/app server 110 are coupled to a network 106. In some embodiments, the devices 102A-N and host server 100 may be directly connected to one another.

The input mechanism on client devices 102A-N having a unified interface for consolidated access of cross-application events and related contacts can include touch screen keypad (including single touch, multi-touch, gesture sensing, etc.), a physical keypad, or a combination of the above. The unified access user interface/environment disclosed herein can be actuated and interacted with using any conventional or known input device including but not limited to physical keyboard, touch screen display, motion sensor, microphone, mouse, other types of pointer devices and any additional input device. The unified access and managements of cross-application features, events and contacts functionality can be provided locally by the client devices 102A-N and used to access applications (e.g., including mobile applications), accounts, websites, services, documents, files, media, or any other content such as those provided by a third party hosts (e.g., application server/content provider of various services 110A-N).

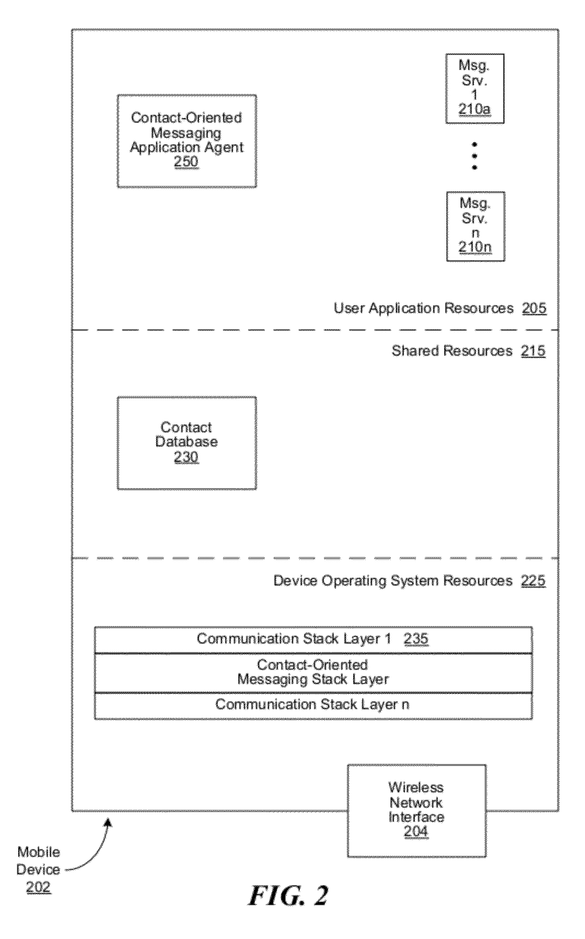

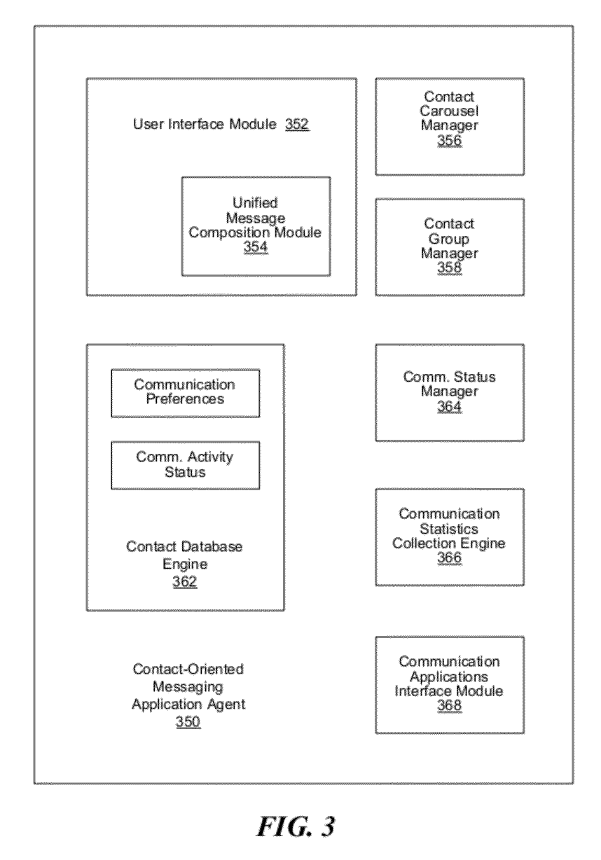

The unified interface for consolidated or simultaneous access of application events and associated contacts can be provided locally by the devices 102A-N through the mobile device manufacturer, provided through the device operating system, by a network service provider, through a downloaded widget from a third party site, network service provider, or from the host server 100. The unified interface for consolidated or simultaneous access of application events and associated contacts may also be provided and enabled on a per application/content basis based on the services provided by the application server/content provider 110 via a contact-oriented messaging application. Functions and techniques performed by the contact-oriented messaging application on devices 102A-N for unified application and contacts management and access and the related components therein are described in detail with further reference to the example of FIGS. 2-3.

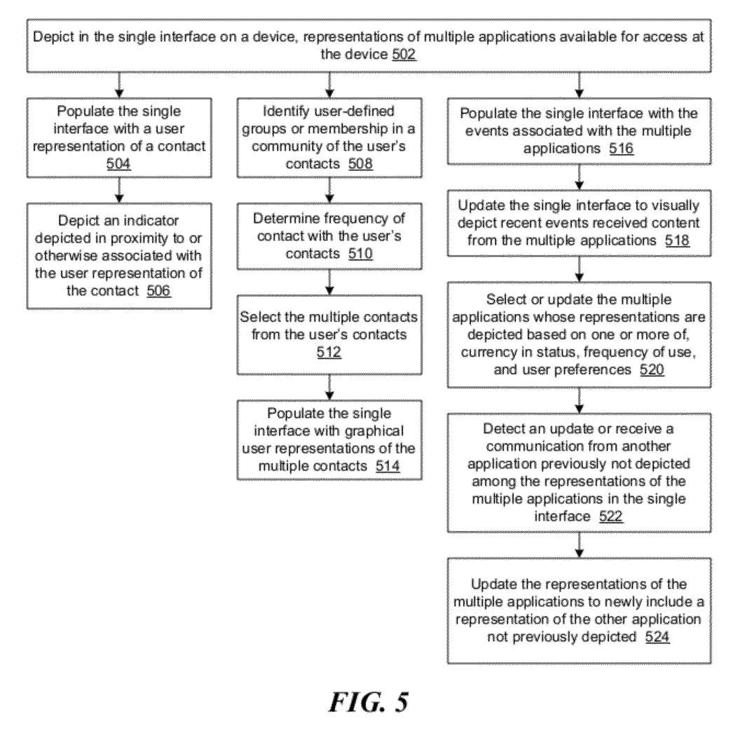

In one embodiment, unified application and contacts management functionalities are in part or in whole provided remotely to the devices 102A-N, for example by the host server 100. For example, the host server 100 can include a multi-application contact-oriented engine 150 accessible over the network 106 by devices 102 to enable features such as UI or UE features for concurrent access and management of events and related contacts, such as those that will be described with further references to description associated with example flow charts FIG. 5-7. The unified application and contacts management UI/UE functionalities, when provided remotely, may be accessed by the devices 102 in the cloud. In addition, the unified application and contacts management UI/UE configured as a as result thereof, may be streamed to the devices 102 on demand, for example, based either on local processes occurring on the device 102 itself or based on processes driven by applications or services provided by the app server/content provider 110.

Functions and techniques performed by a user environment rendering engine for unified application and contacts management, which can reside on the client devices 102 in part or in whole and/or or host server 100 in part or in whole and the components therein are described in detail with further references to the examples of FIGS. 2-3.

For example, the unified application and contacts management user interface assists a user with managing messages from multiple applications and communications channels in a productive and efficient manner. In some embodiments, the unified user interface is configured for a mobile device (or for that matter, any type of device including tablets, laptops or PCs) that provides a unified and integrated means of accessing a user's messages, updates, notifications, or other events and interacting with multiple messaging applications and communications channels.

Some applications can include those used to read and generate emails, instant messages, SMS messages, or other forms of messages. The messaging applications and communications channels may also include social network based applications such as Facebook, Twitter, LinkedIn, or the like. Thus, the disclosed unified user interface/user environment provides a more efficient and user friendly interface to enable a user to interact with multiple applications and communication channels.

In one embodiment, the disclosed unified interface further enables a user to perform the most commonly accessed functions of each of multiple mobile applications without having to launch or interact with the entire application. This allows a user to have an integrated view of these functions across multiple applications and communications channels. This provides a user with a more efficient way to check the status, notifications, or inbox (or its equivalent) of multiple communication modes without having to launch and navigate through each of multiple messaging applications or communications channels.

Further, in one embodiment, the unified UI for access and management of events is contact-based and not application based so it provides a more efficient way for a user to interact with a contact regardless of the contact's means of communication or preferred mode of messaging.

The network 106, over which the client devices 102A-N, the host server 100, and/or app servers 110A-N communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, and other services through any known or convenient protocol, such as, but is not limited to, the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

FIG. 1B illustrates examples of devices with user environments/user interfaces 104A-N able to provide unified access and management of events across multiple applications and the associated contacts with support of servers and services across one or more networks.

Mobile devices 102A-N may communicate with one another and with non-mobile devices through a wireless network, a wireless network support infrastructure, a public network and/or multiple services 110A-N. The wireless network may incorporate and/or participate in a communication network utilizing any suitable wireless communication protocol including wireless telephony protocols and wireless internet protocols. The public network may incorporate and/or participate in a global computer network. In at least one embodiment, the public network may be replaced by and/or supplemented with one or more private and/or enterprise networks.

The application hosts/services 110A-N may correspond to different modes or types of communication. For example, the application hosts/services 110A-N can include voicemail, email, a short messaging service (e.g., SMS), chat (e.g., internet relay chat), instant messaging (IM), fixed length text messages viewable by a set of subscribers (e.g., “TWITTER”), and personal status updates viewable by a set of authorized subscribers (e.g., “FACEBOOK”). The messages communicated with the services 110A-N can incorporate any suitable media format including plain text, formatted text, rich text, graphics, images, audio, video, animations and simulations. In one embodiment, one or more of the services 110A-N can be incorporated into the wireless network support infrastructure.

The wireless network support infrastructure may include a set of wireless infrastructure servers facilitating a wide variety of wireless infrastructure services including communication connection switching and/or routing, service provisioning and/or repair, resource usage monitoring and/or billing, as well as security and/or anti-fraud services. The wireless network support infrastructure may further include a set of public network edge servers that facilitate and govern communication between the wireless network and the public network.

Still further, the wireless network support infrastructure may include a set of contact-oriented messaging infrastructure servers 150 collectively configured at least to facilitate contact-oriented messaging by users of mobile devices 102A-N with respect to the messaging services. Particular contacts of a user of contact-oriented messaging may each make use of multiple of the applications or services for various purposes. In at least one embodiment, contact-oriented messaging enables the user to monitor the multiple messaging services in a contact-oriented manner. For example, the contact-oriented messaging infrastructure servers 150 may facilitate a contact-oriented messaging interface (e.g., a graphical user interface) at one or more of the mobile devices 102A-N that can be configured to provide a unified view of a contact's events or activity across multiple of the applications or services, as well as a mechanism to facilitate communication with the contact via the contact's preferred messaging service(s).

Various aspects of contact-oriented messaging can be customized and/or configured with a contact-oriented messaging web user interface (e.g., an application programming interface or a graphical user interface) accessible via the public network (as shown in FIG. 1B) and/or incorporated into the wireless network support infrastructure. Such a user interface may be accessible with a public network client (e.g., a personal computer incorporating a web browser) connected to the public network and/or a mobile device (e.g., incorporating a mobile web browser)

FIG. 2 depicts a block diagram illustrating example components of mobile device architecture which provides capabilities including user interface features and functions for unified access and management of events across multiple applications and the associated contacts.

As used in this paper, a “module,” a “manager,” a “handler,” or an “engine” includes a general purpose, dedicated or shared processor and, typically, firmware or software modules that are executed by the processor. Depending upon implementation-specific or other considerations, the module, manager, handler, or engine can be centralized or its functionality distributed. The module, manager, handler, or engine can include general or special purpose hardware, firmware, or software embodied in a computer-readable (storage) medium for execution by the processor. As used in this paper, a computer-readable medium or computer-readable storage medium is intended to include all mediums that are statutory (e.g., in the United States or under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, etc.), but may or may not be limited to hardware.

The mobile device may include multiple messaging applications implemented with a set of user application resources of the mobile device. The multiple messaging applications may correspond to the multiple messaging services described above with reference to FIG. 1. The mobile device may further include a communication stack (e.g., a messaging protocol stack such as a TCP/IP stack) incorporating multiple layers configured at least to facilitate communication with one or more wireless network interfaces. The communication stack may be incorporated into and/or implemented with a device operating system set of resources of the mobile device. The communication stack may include a contact-oriented messaging stack layer configured at least to monitor characteristics of messages and/or messaging patterns over time to and/or from the messaging applications. Such monitored information may be available to a contact-oriented messaging application implemented with the user application resources of the mobile device.

The mobile device may maintain a contact database that is shared to various degrees with the messaging applications and the contact-oriented messaging application. Access to the contact database may be subject to various controls and/or policies enforced by an operating system of the mobile device. For example, different applications may have no access, read-only access, read-update access and/or read-update-create access to the contact database. The contact database may include authoritative contact details for the contacts of one or more users of the mobile device. In at least one embodiment, the wireless network support infrastructure may maintain a back-up copy of the contact database.

FIG. 3 depicts a block diagram illustrating example components of a contact-oriented messaging agent 350 to facilitate unified access and management of events across multiple applications and associated contacts.

The contact-oriented messaging agent 350 can include, for example, a user interface module 352 having a unified message composition module 354, a contact carousel manager 356, a contact group manager 358, a contact database engine 362, a communication status manager 364, a communication statistics collection engine 366 and/or a communication applications interface module 368. Additional or less components/modules/engines can be included in the contact-oriented messaging agent 350.

As used in this paper, a “module,” a “manager,” a “handler,” or an “engine” includes a general purpose, dedicated or shared processor and, typically, firmware or software modules that are executed by the processor. Depending upon implementation-specific or other considerations, the module, manager, handler, or engine can be centralized or its functionality distributed. The module, manager, handler, or engine can include general or special purpose hardware, firmware, or software embodied in a computer-readable (storage) medium for execution by the processor. As used in this paper, a computer-readable medium or computer-readable storage medium is intended to include all mediums that are statutory (e.g., in the United States or under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, etc.), but may or may not be limited to hardware.

The contact-oriented messaging application 350 may include a user interface module 352 configured at least to maintain a graphical user interface. The graphical user interface may include a contact carousel presenting a representation of a subset of contacts of the application user, and created or managed by the contact carousel manager 356. For example, the contact carousel may include 5-10 same sized images, photographs or representative graphical “avatars” corresponding to the subset of contacts. The contact carousel may respond to user indications (e.g., touch screen input) by rotating to display different subsets of the user's contacts.

The displayed subsets of the user's contacts and/or an order that the user's contacts are located in the contact carousel may be determined by a contact carousel manager 356. The determinations of the contact carousel may be based on a variety of suitable factors including the user's communication patterns (e.g., with respect to the user's contacts and/or with respect to the messaging services) such as frequency and freshness of communication, the user's level of interest in a particular contact (e.g., indicated explicitly or detected algorithmically based on communication history), and a level of interest of the contact in the user (e.g., indicated explicitly or detected algorithmically based on communication history).

Such determinations, and furthermore any suitable determinations of the contact-oriented messaging application 350, may be based on statistics maintained by a communication statistics collection engine 366. The communication statistics collection engine 366 may collect relevant communication statistics from any suitable source including the messaging applications on the mobile device, the contact database on the mobile device, the contact-oriented messaging stack layer in the device operating system, the wireless network support infrastructure, the contact-oriented messaging infrastructure servers; the contact-oriented messaging web user interface, and/or the application services (e.g., via an application programming interface of the messaging services).

When a representative portion of the contact carousel is selected by a user of the contact-oriented messaging application 350, the user interface may present a unified status of the selected contact with respect to activity at a set of the messaging services. The communication activity status for each contact may be maintained in a contact overlay database that references and augments the authoritative contact database of the mobile device. The communication activity status for each contact may be maintained by a communication status manager 364 configured at least to determine and/or update such status, for example, based at least in part on statistics maintained by the communication statistics collection component. Access to the messaging applications of the mobile device and/or to information maintained by the messaging applications may be facilitated by a communication applications interface module 368.

Communication with a selected contact may be facilitated by a unified message composition module 354 of the user interface module 352. The unified message composition module 354 may provide unified composition with respect to messages of multiple messaging services and/or applications, and/or facilitate access to mode-specific message composition with the corresponding messaging application. For example, the unified message composition module 354 can cause the communication applications interface module 368 to launch and/or switch to the corresponding messaging application. The unified message composition module 354 may determine the selected contact's preferred mode of communication, for example, based on the contact's communication preferences stored in the contact database overly and/or algorithmically.

The contact carousel 356 may include representative portions corresponding to groups of contacts. Such groups may be specified explicitly by the user in the contact database and/or the contact database overlay. The user interface module 352 of the contact-oriented messaging application 350 and/or the contact-oriented messaging web user interface may include user interface components for specifying such groups. In at least one embodiment such groups may be algorithmically determined, for example, by a contact group management manager 358. Examples of such groups include contacts associated with most recent communications, as well as highest volume of communications over a time period and/or with respect to a particular set of messaging services.

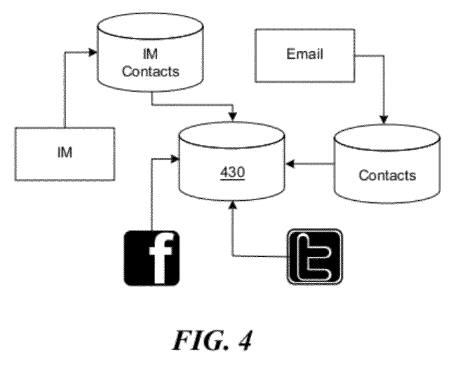

FIG. 4 depicts a block diagram 400 showing contact mapping of a user's contacts across multiple sources into a single contact database 430.

The user's contacts across services or applications, the mobile device, the SIM card, IM services, and/or email contacts can be merged into the single contact database. The contact database 430 is typically accessible by a user via a mobile device but stored remotely (e.g., accessed via a host server 100). The contacts can be aggregated from the mobile device or from remote hosts/services. In some embodiments the contacts can be sync'ed, merged, and/or de-duplicated.

In some instances, an aggregated communication event database, which holds communication events from multiple services (IM, chat, phone, email, tweet, post, etc.), is created. The communications event database can be included in the contact database 430 or it can be a separate database. The communications event database data can be used to infer a preferred communication method for a user or as a data mining source that enables the inference of other information that allows system optimization of the user experience or of the network traffic generated by the user's communication events.

FIG. 5 depicts a flow chart illustrating example processes through which multi-application access of associated events can be enabled via a single interface.

In process 502, representations of multiple applications available for access at the device are depicted. In one embodiment, each of the representations in the single interface, are selectable or actionable to access application features of a corresponding application in a different interface. The multiple applications can include different communication channels including, one or more of, voice chat, IM chat, SMS, email. The applications can also include social networking applications or other types of applications/services or web-based services. In one embodiment, arrangements of the representations of the multiple applications in the single interface are user configurable and adjustable via touch gestures with respect to a physical screen of the device.

In process 504, the single interface is populated with a user representation of a contact. The contact can be a subject of one or more of the recent application or communication updates.

In process 506, an indicator is depicted in proximity to or otherwise associated with the user representation of the contact. In one embodiment, the indicator is selectable to initiate communication via a communication channel with the contact. The communication channel represented by the indicator associated with the user representation of the contact may include a preferred mode of communication for the contact. In general, the indicators in the user interface are selectable via touch screen gesture at a physical screen of the device, or any other touch, scroll, select, point, audio, input means.

In process 508, user-defined groups or membership in a community of the user's contacts are identified.

In process 510, frequency of contact with the user's contacts is determined.

In process 512, the multiple contacts are selected from the user's contacts.

In process 514, the single interface is populated with graphical user representations of the multiple contacts. In general, each of the graphical user representations of the multiple contacts are selectable or actionable to access, in the single interface, applications through which a communication event with an associated contact of the selected graphical user representation is able to be initiated

The graphical user representations of the multiple contacts can be in the form of a carousel showing a sequence of images representing the contacts, where, the carousel is manipulable via a scrolling action to view the multiple contacts and additional contacts not depicted in the single interface.

In process 516, the single interface is populated with the events associated with the multiple applications. The associated events can include, notifications or content, user updates, application updates, emails, messages, updates in application status, etc.

In process 518, the single interface is updated to visually depict recent events received content from the multiple applications.

In process 520, the multiple applications whose representations are depicted are selected or updated based on one or more of, currency in status, frequency of use, and user preferences.

In process 522, an update is detected or a communication is received from another application previously not depicted among the representations of the multiple applications in the single interface.

In process 524, the representations of the multiple applications are updated to newly include a representation of the other application not previously depicted.

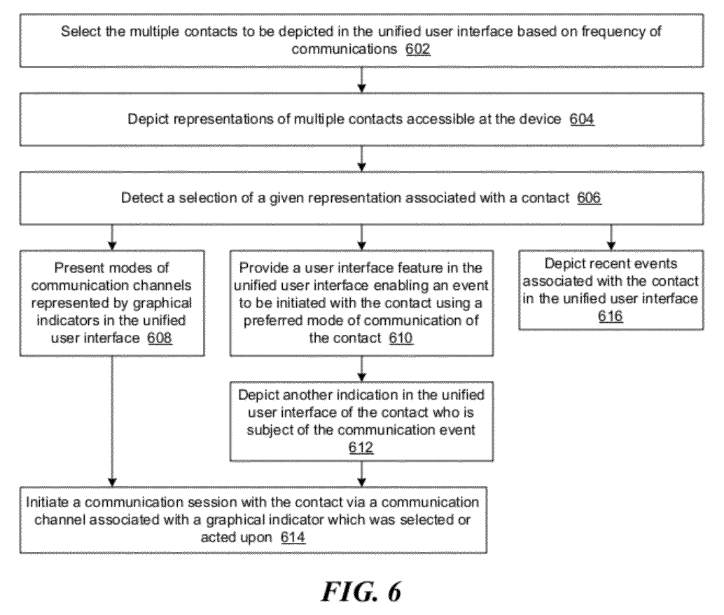

FIG. 6 depicts a flow chart illustrating an example process for facilitating communication with a user via multiple applications through a unified user interface on a mobile device.

In process 602, the multiple contacts to be depicted in the unified user interface are selected based on frequency of communications. For example, messaging patterns with respect to the multiple contacts can be monitored and communication statistics can be computed from the messaging patterns.

In process 604, representations of multiple contacts accessible at the device are depicted. The multiple contacts can be selected from an aggregation of contacts or friends of the user across multiple applications and/or stored on multiple devices. The multiple contacts that are depicted in the single interface can be further determined based on a user-defined grouping or membership in a community.

In process 606, a selection of a given representation associated with a contact is detected. In process 608, modes of communication channels represented by graphical indicators in the unified user interface are presented.

In process 610, a user interface feature in the unified user interface enabling an event to be initiated with the contact using a preferred mode of communication of the contact. In process 612, another indication in the unified user interface of the contact who is subject of the communication event. In process 614, a communication session is initiated with the contact via a communication channel associated with a graphical indicator which was selected or acted upon. In process 616, recent events associated with the contact are depicted in the unified user interface. The recent events that are depicted can be in the form of one or more of, for instance, updates, notifications or contents of communication

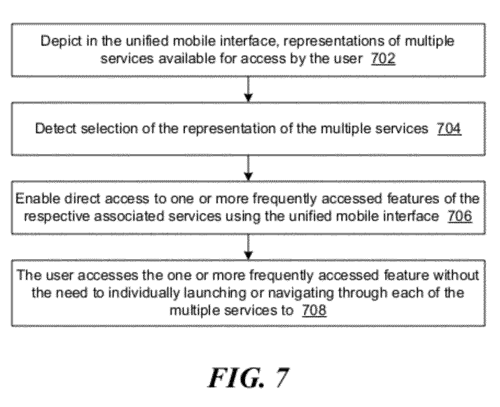

FIG. 7 depicts a flow chart illustrating example process for simplifying navigation to access frequently accessed features of multiple services.

In process 702, representations of multiple services available for access by the user are depicted in the unified mobile interface. In one embodiment, the multiple applications whose representations are depicted is selected and updated based on one or more of, currency in status, frequency of use, and user preferences, etc.

In process 704, a selection of the representation of the multiple services is detected. In process 706, direct access to one or more frequently accessed features of the respective associated services is enabled using the unified mobile interface.

In process 708, the user accesses the one or more frequently accessed feature without the need to individually launch or navigate through each of the multiple services. In general, each of the representations in the single interface, are selectable or actionable to access application features of a corresponding application in a different interface.

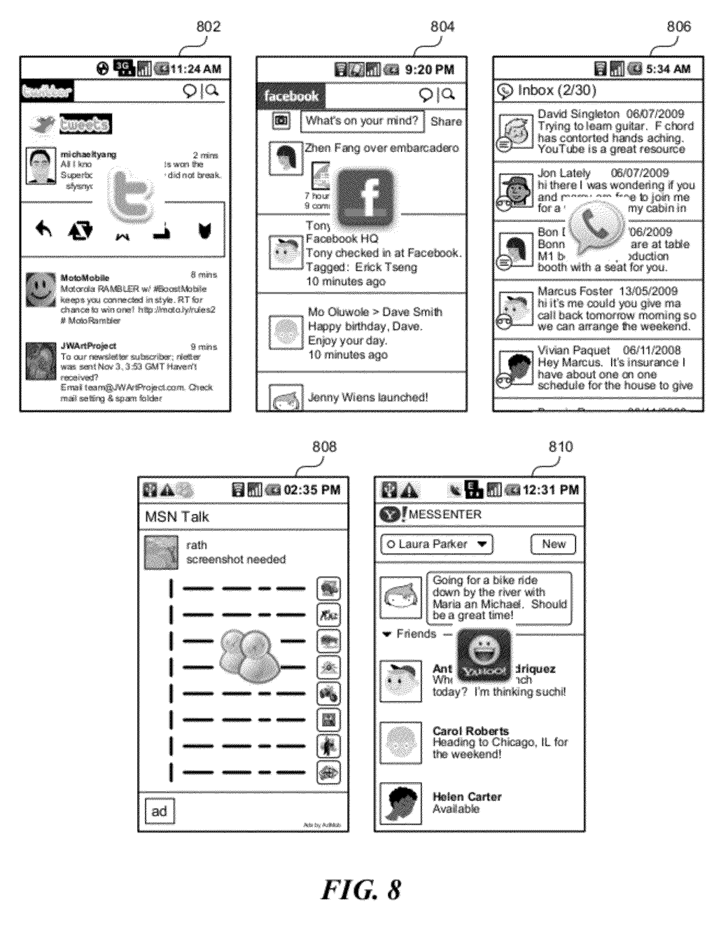

FIG. 8 depicts example screenshots showing how multiple applications, their events, updates, and the associated contacts are scattered across multiple different user interfaces 802, 804, 806, 808, 810.

These screenshots depict how any task requires that the corresponding application be engaged and that similar tasks across different applications (e.g., the chat feature of different applications) require the launching of all the applications to access the chat feature of the respective application. Moreover, simple tasks such as emailing, messaging, or sending an SMS typically requires launching the full application and navigating through several screens to access the desired feature/functionality. In general, a user's contacts and applications are scattered and there is no simple way to access or view all of the user's contacts and services.

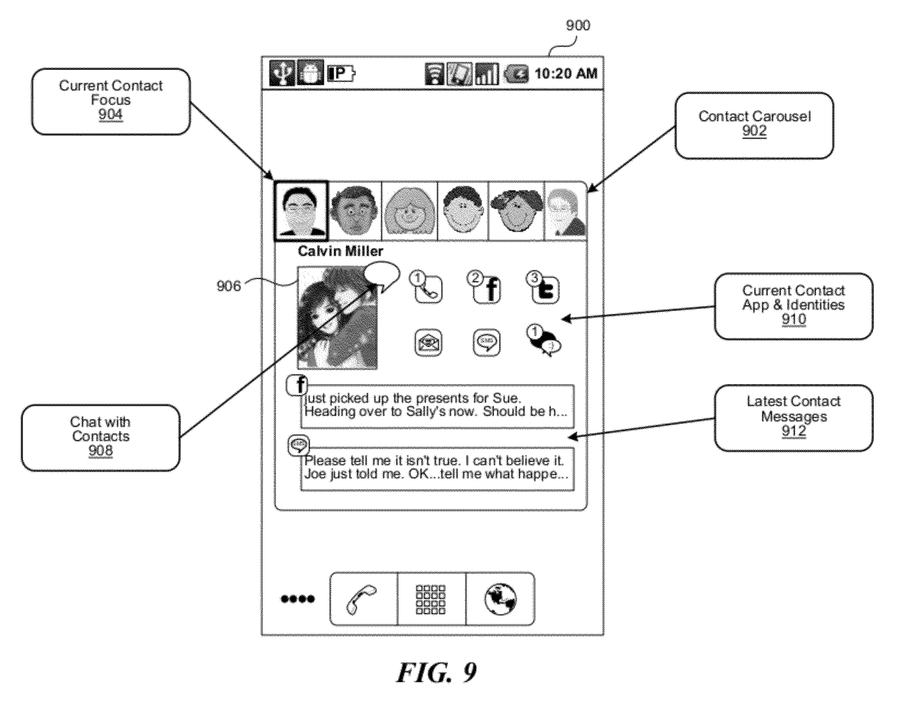

FIG. 9 depicts an example screenshot showing how multiple applications, their events, updates, and the associated contacts which are typically scattered across multiple different user interfaces can be unified in a single interface 900 in a mobile user environment.

The user interface or user environment of the single interface can be viewed as a social dashboard which combines a quick visual overview of messages/statues from a user's applications or other services, including but not limited to, presence information, SMS, MMS, calls, IM, chat messages, other messages, blog entries, status updates, news feeds, Tweets, voicemail, etc. The visual overview can also integrate features enabling the user to respond or to initiate communication with a given contact via a given network or application (e.g., view or respond to a message, blog, text, or listen/respond to a voicemail, etc.). The dashboard, or the single interface integrates with device applications, the mobile platform, third party applications/services, phone features (calling, SMS), or device features.

The user interface can display a unified view of all of the user's communications services, and may include, but is not limited to elements such as:

an indication of the current (or active) contact 906 that is the subject of a communication;

a carousel 902 showing a sequence of images of contacts or of a group of contacts, where the group may be selected based on one or more criteria (a business, social, or family grouping, etc., or the most recent or most used contacts, etc.)

an indication 910 of the current contact's available messaging methods or preferred method(s)

one or more of the current contact's most recent messages 912 (with, if applicable, an indication of the messaging platform or application used)

one or more icons or activate-able elements that may be used to initiate a communication with a current contact using a default or preferred communication channel for that contact 908;

icons, activate-able elements, or tools 908 to enable a user to efficiently review and respond to messages from the current contact; and

an activate-able element 910 to enable a user to launch a messaging or social network application to permit use of a larger set of the functions or capabilities of the application.

In one embodiment, the unified user interface and rendering engine therefor may be capable of updating some or all of the communication channels and messaging applications in response to a user's change in status or availability for communicating. Furthermore, the user interface/user environment rendering engine provides for the prioritization of communication events on a device within an individual service or across multiple services (IM, chat, phone, email, tweet, post, etc) to allow a user to see the most important communications first and to optimize the underlying delivery of the content to conserve network bandwidth.

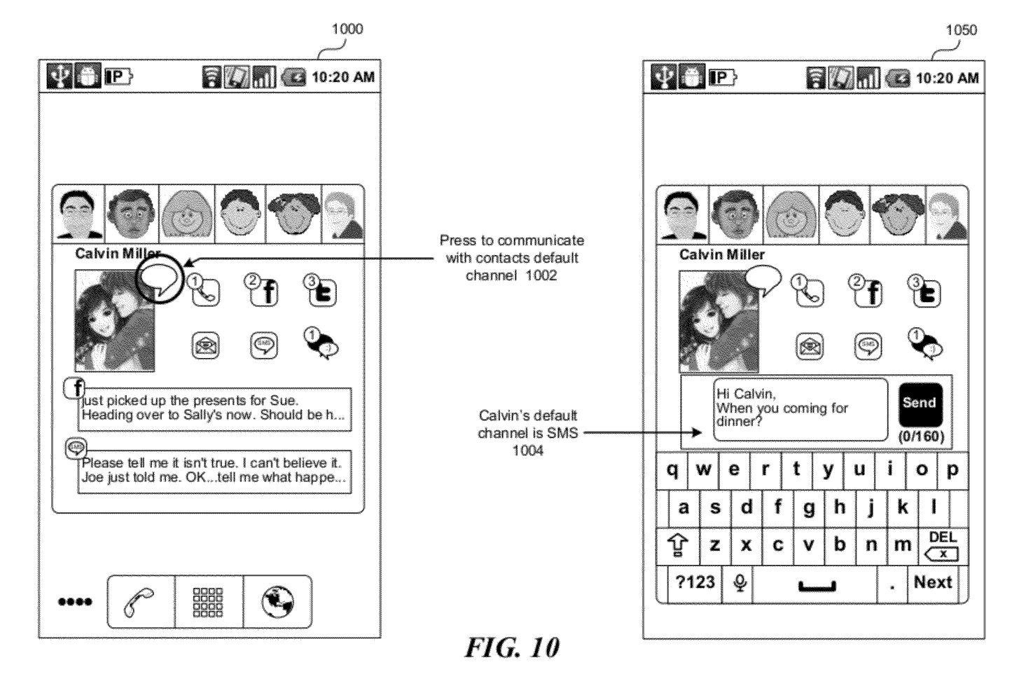

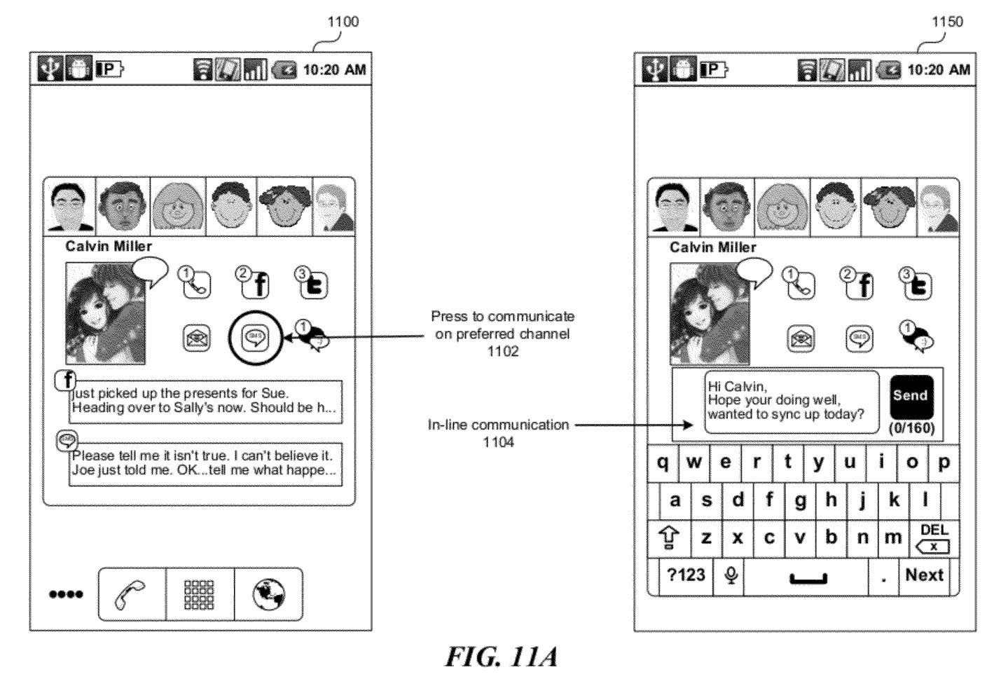

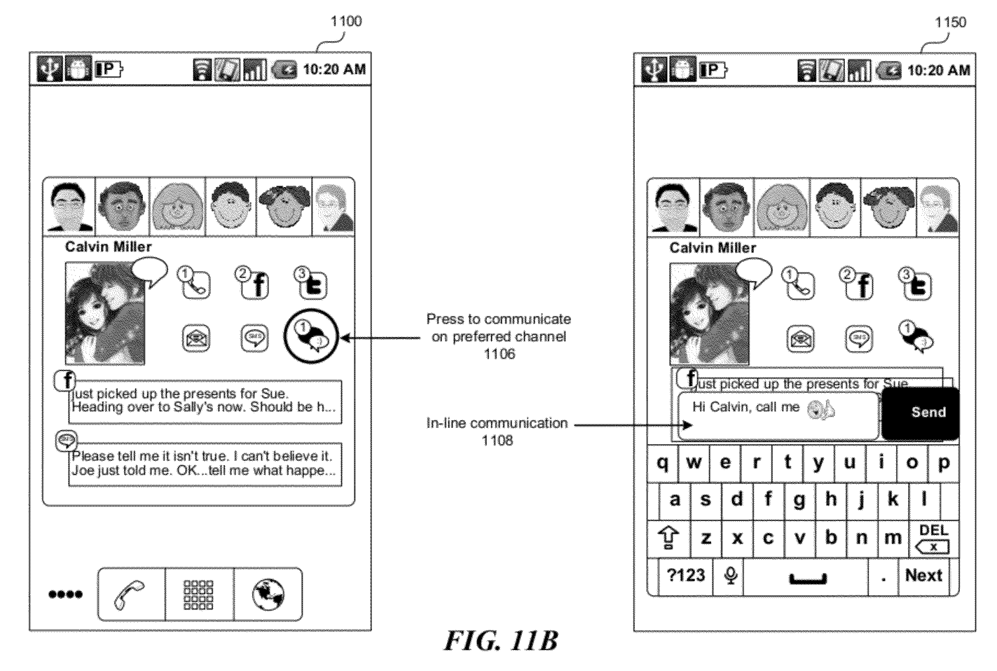

FIG. 10 depicts example screenshots 1000 and 1050 of a unified user interface for accessing contacts, applications/updates, and an indicator 1002 for a default communication channel which can be used to initiate a communication session 1004 with an active contact in the unified user interface. FIGS. 11A-B depict example screenshots 1100 and 1150 of a unified user interface for accessing contacts, applications/updates, and indication 1102 and 1106 of a preferred communication channel of the active contact which can be activated to initiate communication 1104 and 1108 with the active contact.

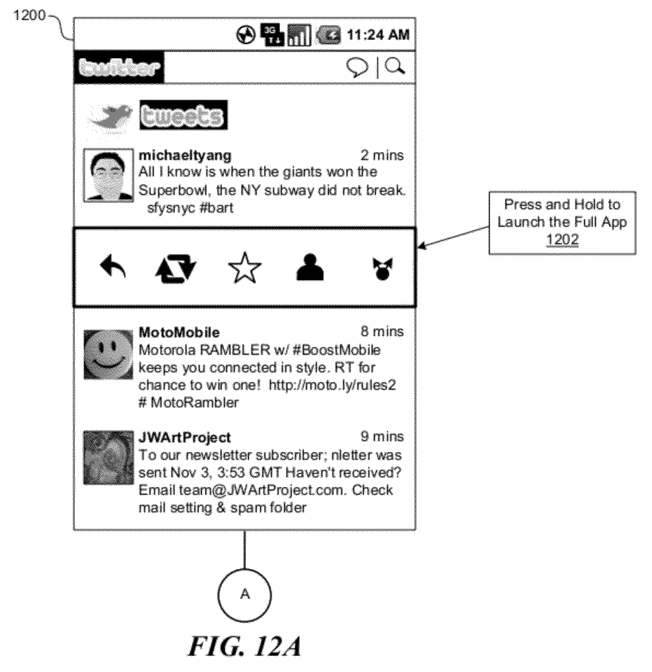

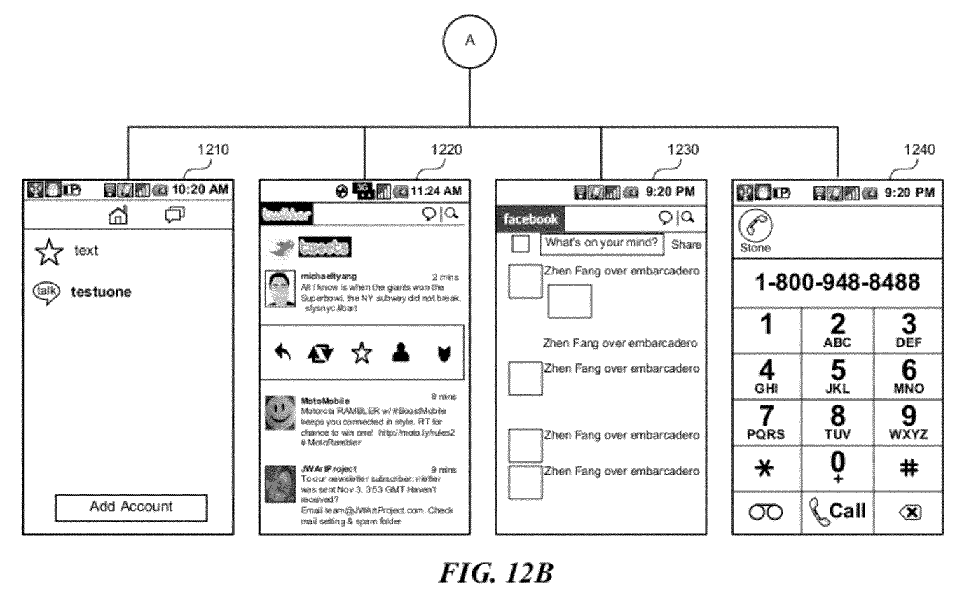

FIGS. 12A-B depict example screenshots of a unified user interface 1200 where a representation of an application is selectable or actionable 1202 to access its additional features in a different interface (e.g., 1210, 1220, 1230, or 1240).

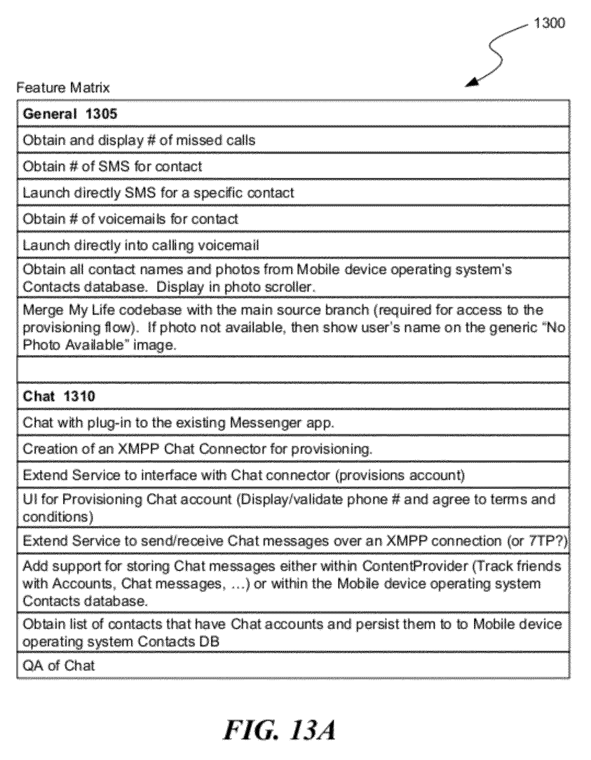

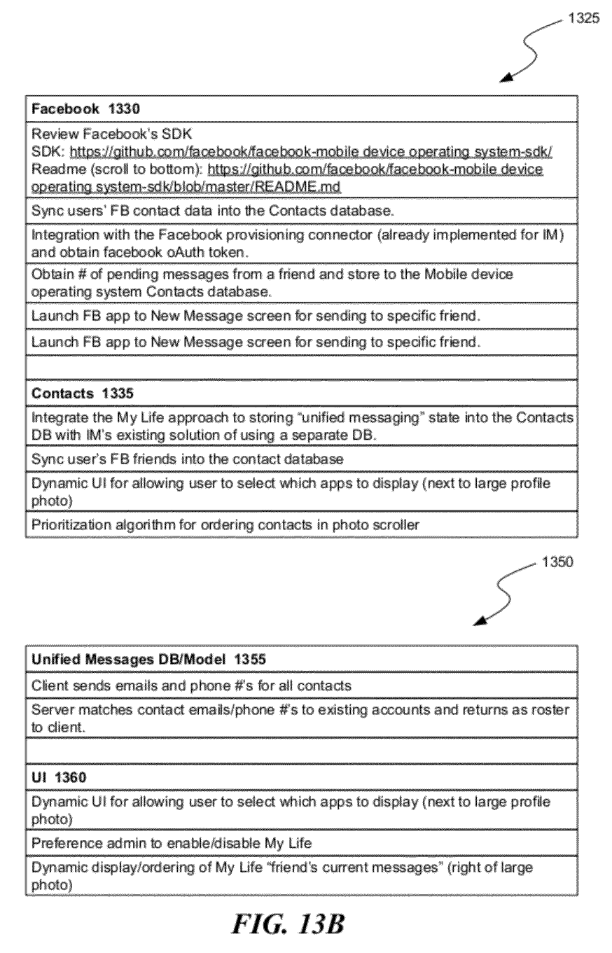

FIGS. 13A-B depict tables listing example features of across multiple applications which can be provided via a unified interface for access and management. Some examples include:

Facebook

provisioning and listing of friends' IM statuses.

Detect whether the Facebook application is installed.

Syncing of the user's Facebook friend list with the phone's Contacts database

Sync Facebook Inbox messages (read/unread).

Launch a user directly into an existing Facebook message from a specific friend

Launch user directly into a new Facebook message to a specific friend

Sync status updates from Facebook friends including new feeds, status updates, messages, etc.

Launch Facebook directly

Contact Photo Import Tasks

The organization of messages around a user's friends can be further enhanced by displaying a friend's photos. In one embodiment, the user interface engines is able aggregate and/or synchronize syncing of friends' photos from the mobile phone or external services such as, Flickr, Twitter or Facebook, etc. The processes can include:

1. Obtain a friend's photo from a contact provider, a contact database, the mobile phone, or another service.

2. Server-side implementation of Facebook providing syncing of friend photos.

3. Sync Twitter photos or photos from any other services

4. Determination of priority of the aggregated photos

5. All added to the provisioning process.

6. Application Integration Tasks

Email and IM

The email and/or IM services can be integrated for both inbound message notification as well as outbound reply

launching of pre-populated email/IM activities.

An example of the methods to integrate IM/chat/email applications include:

Email

1. Launch Email with pre-populated email address of selected friend.

2. Map Email Contacts (device phone contacts) to contacts in other apps.

IM

1. Launch 27 IM directly into last IM chat with selected friend or launch new chat

2. Map 27 IM Contacts (separate Contacts table in Z7ContentProvider) to contacts in other apps.

Voicemail

Determine how to interact with the relevant Voicemail app.

1. Listen for incoming voicemails.

2. Determine how to detect when users have listened to a voicemail.

Missed Calls

Determine how to interact with the relevant Phone app.

1. Listen for incoming calls and track when they have been missed.

2. Determine how to “clear” missed calls when they have been “acknowledged”.

3. The “Missed Calls” count may be displayed over the user interface phone icon in a bubble separate from the “Pending Voicemails” count.

4. When a user clicks the Phone icon and both Missed Calls and Voicemails are present

Missed SMS

Determine how to interact with the relevant SMS application.

1. Listen for incoming SMS messages

2. Listen for reading of SMS messages.

3. Launch into SMS app and pre-populate with a specific contact's phone number.

Twitter

1. Detect whether a Twitter client is installed.

2. Supports the Twitter app developed by Twitter itself.

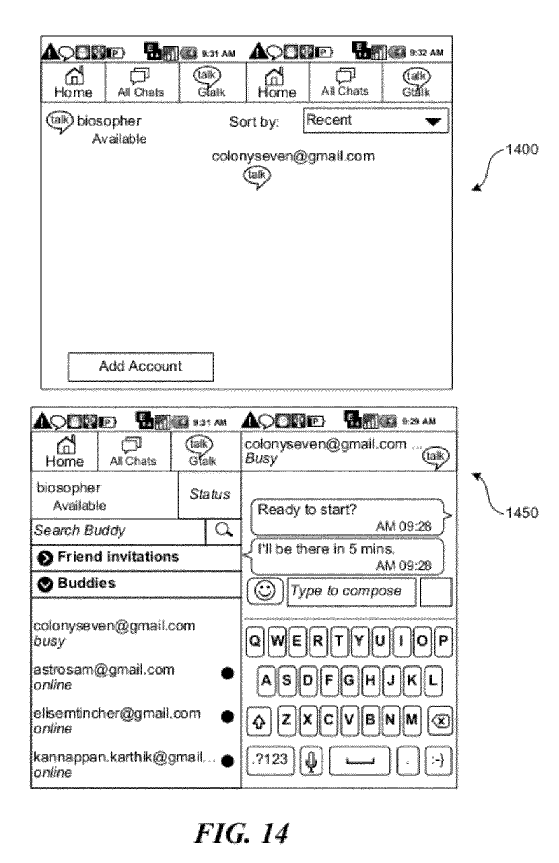

FIG. 14 depicts screenshots 1400 and 1450 showing a chat application utilizing SMS-based registration.

The chat application can be used with any third party chat applications (e.g., Gtalk, MSN, etc.) including for example XMPP-based messengers. In one embodiment, the ‘join’ button in screenshot 1400 is used to initiate chat provisioning. When the button is selected or clicked, an SMS-based registration process can occur where the client will contact the chat services to create a new account if needed and/or to receive an authentication key. The client can send this key to via SMS to the server. The server can link the phone number from the SMS to the previous authentication key, for example.

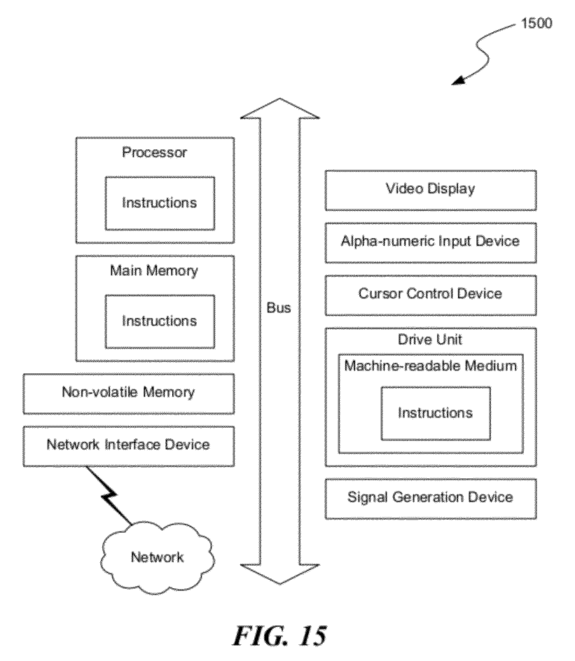

FIG. 15 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples; alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the disclosure.

What is claimed is:

1. A method for enabling multi-application access of associated events via a single interface, the method, comprising:
depicting in the single interface on a device, representations of multiple applications available for access at the device;
wherein, the single interface is further populated with the events associated with the multiple applications;
updating the single interface to visually depict recent events received content from the multiple applications;
wherein, each of the representations in the single interface, are selectable or actionable to access application features of a corresponding application in a different interface.

2. The method of claim 1, wherein, the single interface is further populated with a user representation of a contact; wherein, the contact is a subject of one or more of the recent application or communication updates.

3. The method of claim 2, further comprising, an indicator depicted in proximity to or otherwise associated with the user representation of the contact; wherein, the indicator is selectable to initiate communication via a communication channel with the contact.

4. The method of claim 3, wherein, the communication channel represented by the indicator associated with the user representation of the contact is a preferred mode of communication for the contact.

5. The method of claim 3, wherein, the indicator is selectable via touch screen gesture at a physical screen of the device.

6. The method of claim 1, wherein, the multiple applications include communication channels including, one or more of, voice chat, IM chat, SMS, email.

7. The method of claim 1, wherein, the multiple applications include social networking applications.

8. The method of claim 1, wherein, the associated events include notifications or content.

9. The method of claim 1, wherein, the associated events include updates in application status.

10. The method of claim 1, further comprising, selecting and updating the multiple applications whose representations are depicted based on one or more of, currency in status, frequency of use, and user preferences.

11. The method of claim 1, wherein, arrangements of the representations of the multiple applications in the single interface are user configurable and adjustable via touch gestures with respect to a physical screen of the device.

12. The method of claim 1, wherein, the representations of the multiple applications is updated to newly include a representation of another application responsive to detecting an update or receiving a communication from the other application previously not depicted among the representations of the multiple applications in the single interface.

13. The method of claim 1, wherein, the single interface is further populated with graphical user representations of multiple contacts accessible at the device.

14. The method of claim 13, wherein, the multiple contacts that are depicted in the single interface is selected based on a user-defined grouping or membership in a community.

15. The method of claim 13, wherein, the multiple contacts that are depicted in the single interface is determined based on frequency of contact.

16. The method of claim 13, wherein, each of the graphical user representations of the multiple contacts are selectable or actionable to access, in the single interface, applications through which a communication event with an associated contact of the selected graphical user representation is able to be initiated.

17. The method of claim 13, wherein, the graphical user representations of the multiple contacts is in the form of a carousel showing a sequence of images representing the contacts, wherein, the carousel is manipulable via a scrolling action to view the multiple contacts and additional contacts not depicted in the single interface.

18. A method of a unified user interface to facilitate communication with a user via multiple applications via a mobile device, the method, comprising:
depicting a representations of multiple contacts accessible at the device;
wherein, the multiple contacts that are depicted in the unified user interface is determined based on frequency of communications;
responsive to detecting a selection of a given representation associated with a contact, presenting modes of communication channels represented by graphical indicators in the unified user interface.

19. The method of claim 18, further comprising,
providing a user interface feature in the unified user interface enabling an event to be initiated with the contact using a preferred mode of communication of the contact, in response to the selection of the given representation of the contact;
depicting another indication in the unified user interface that the contact is a currently active contact who is subject of the communication event.

20. The method of claim 19, further comprising, initiating a communication session with the contact via a communication channel associated with a graphical indicator which was selected or acted upon.

21. The method of claim 19, wherein, recent events associated with the contact is depicted in the unified user interface; the recent events being depicted in the form of one or more of, updates, notifications or contents of communication.

22. The method of claim 19, wherein, the multiple contacts are selected from an aggregation of contacts or friends of the user across multiple applications.

23. The method of claim 19, wherein, the multiple contacts are selected from an aggregation of contacts of the user stored on multiple devices

24. The method of claim 19, wherein, the multiple contacts that are depicted in the single interface is further determined based on a user-defined grouping or membership in a community.

25. A machine-readable storage medium having stored thereon instructions, which when executed, cause a processor to perform a method to simplify navigation to access frequently accessed features of multiple services, the method, comprising:
depicting in the unified mobile interface, representations of multiple services available for access by the user;
wherein, the representations of the multiple services are selectable to directly access one or more frequently accessed features of the respective associated services using the unified mobile interface,
such that the user need not individually launch and navigate through each of the multiple services to access the one or more frequently accessed features.

26. The method of claim 25,
further depicting representations of multiple contacts via the unified mobile interface;
responsive to detecting a selection of a given representation associated with a contact, presenting modes of communication channels represented by graphical indicators in the unified user interface.

27. The method of claim 25, wherein, the one or more frequently accessed features include, one or more of, email, messaging, status updating.

28. The method of claim 25, further comprising:
wherein, the unified mobile interface is further populated with the events associated with the multiple services;
updating the single interface to visually depict recent events received content from the multiple applications;
wherein, each of the representations in the single interface, are selectable or actionable to access application features of a corresponding application in a different interface.

29. A method for enabling simultaneous multi-application viewing of associated events via a single interface, the method, comprising:
depicting in the single interface on a device, representations of multiple applications available for access at the device;
wherein, the single interface is further populated with the events associated with the multiple applications;
updating the single interface to simultaneously depict recent events or received content across the multiple applications;
wherein, each of the representations in the single interface, are selectable or actionable to access application features of a corresponding application in a different interface.

30. A system of a unified user interface to facilitate communication with a user via multiple communication channels, the system, comprising:
means for, depicting a representations of multiple contacts accessible at the device;
means for, monitoring messaging patterns with respect to the multiple contacts;
wherein, the multiple contacts that are depicted in the unified user interface is determined based on the messaging patterns;
means for, detecting a selection of a given representation associated with a contact,
means for, presenting modes of communication channels represented by graphical indicators in the unified user interface;
means for, determining a preferred mode of communication of the contact;
means for, providing a user interface feature in the unified user interface enabling an event to be initiated with the contact using the preferred mode of communication.

31. The system of claim 30, further comprising, means for, computing communication statistics from the messaging patterns.

32. The system of claim 30, wherein, the messaging patterns include frequency of contact.

33. The system of claim 30, further comprising:
means for, aggregating the multiple contacts from contacts or friends of the user across multiple applications.
